(19) United States
(12) Patent Application Publication
(10) Pub. No.: US 2007/0201060 A1
(43) Pub. Date: Aug. 30, 2007

(54) IMAGE PROCESSING APPARATUS, IMAGE PROCESSING METHOD, IMAGE PROCESSING PROGRAM, AND RECORDING MEDIUM

(76) Inventor: Hiroaki FUKUDA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/668,201

(22) Filed: Jan. 29, 2007

(30) Foreign Application Priority Data
Feb. 28, 2006 (JP) 2006-052807

(51) Int. Cl. G06F 3/12

(52) U.S. Cl. 358/1.9; 358/1.13

(57) ABSTRACT

An input receiving unit receives an input of image data as either a reuse data format with an undefined output destination or a re-output data format with a defined output destination. An image processing unit performs a different image processing on the image data depending on a type of received data format. An accumulating unit accumulates the image data, on which an image processing is performed by the image processing unit, in the received data format in a storage unit.

### CROSS-REFERENCE TO RELATED APPLICATIONS

The present document incorporates by reference the entire contents of Japanese priority document, 2006-052807 filed in Japan on Feb. 28, 2006.

### BACKGROUND OF THE INVENTION

1. Field of the Invention

The present invention relates to a technology for storing image data for reuse.

2. Description of the Related Art

Conventionally, image forming apparatuses having functions of devices, such as a printer, a copier, a facsimile machine, and a scanner, accommodated in one box (hereinafter, “multifunction products (MFPs)”) have been known.

With the expansion of the capability of such MFPs, several technologies have been suggested for once storing input image data and then re-outputting data according to a desire of a user by using the accumulated image data.

For example, in Japanese Patent Application Laid-Open No. 2004-112140, image processing is performed on input image data, and image-area separation data obtained through separation based on whether the data is in an image area or a character area is acquired. The image-area separation data acquired together with the image data is added for accumulation in a hard disk drive (HDD). At the time of output, the accumulated image-area separation data is used to perform image processing on the image data with different parameters for the respective image areas. Also, at the time of performing this image processing, parameters are determined so as to be optimized for the purpose at the output destination at the time of reuse. With this, the accumulated image data is output with appropriate image quality according to the output destination.

However, in the invention disclosed in Japanese Patent Application Laid-Open No. 2004-112140, image quality optimization is performed according to the destination even on image data whose output destination has been already determined at the time of accumulation. In this case, image quality optimization is performed for every printing although the output destination is the same. This poses problems of process waste and reduction in printing speed.

### SUMMARY OF THE INVENTION

It is an object of the present invention to at least partially solve the problems in the conventional technology.

An image processing apparatus according to one aspect of the present invention includes an input receiving unit that receives an input of image data as either a reuse data format with an undefined output destination or a re-output data format with a defined output destination; an image processing unit that performs a different image processing on the image data depending on a type of received data format; and an accumulating unit that accumulates the image data, on which an image processing is performed by the image processing unit, in the received data format in a storage unit.

An image processing method according to another aspect of the present invention includes receiving an input of image data as either a reuse data format with an undefined output destination or a re-output data format with a defined output destination; performing a different image processing on the image data depending on a type of received data format; and accumulating the image data, on which an image processing is performed at the performing, in the received data format in a storage unit.

A computer program product according to still another aspect of the present invention includes a computer usable medium having computer readable program codes embodied in the medium that when executed cause a computer to execute receiving an input of image data as either a reuse data format with an undefined output destination or a re-output data format with a defined output destination; performing a different image processing on the image data depending on a type of received data format; and accumulating the image data, on which an image processing is performed at the performing, in the received data format in a storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of the configuration of an MFP according to a first embodiment;

FIG. 2 is a drawing for explaining, for each item, a difference between a reuse data format and a re-output data format for use in the MFP according to the first embodiment;

FIG. 3 is a drawing for explaining the configuration and order for use until the MFP according to the first embodiment accumulates image data in a storage device as a reuse data format and outputs the image data;

FIG. 4 is a drawing for explaining the configuration and order for use until the MFP according to the first embodiment accumulates image data in the storage device as a re-output data format and outputs the image data;

FIG. 5 is a drawing for explaining the configuration and order for use until the MFP according to the first embodiment outputs image data to the output destination without accumulating the image data in the storage device;

FIG. 6 is a flowchart of a procedure until accumulating image data in the storage device of the MFP according to the first embodiment and outputting the image data to the output destination;

FIG. 7 is a drawing for explaining the configuration and order for use until the MFP according to the first embodiment outputs, according to the output destination, image data in the reuse data format accumulated in the storage device;

FIG. 8 is a drawing for explaining the configuration and order for use until the MFP according to the first embodiment outputs image data as the re-output data format accumulated in the storage device;

FIG. 9 is a flowchart of a procedure until outputting the image data accumulated in the MFP according to the first embodiment;

FIG. 10 is a drawing for explaining the configuration and order for use until the MFP according to the first embodiment accumulates image data in the reuse data format and image-area separation data separated from the image data in the storage device and outputs the image data according to the output destination;

FIG. 11 is a drawing for explaining the configuration and order for use until performing image processing on image data in the reuse data format accumulated in the MFP according to the first embodiment and then outputting the result to a plurality of output destinations;

FIG. 12 is a drawing for explaining the configuration and order for use until an MFP according to a second embodiment reads image data in the re-output data format and bibliographic information from a storage device and performs image processing and output processing according to settings stored in the bibliographic information; and

FIG. 13 is a block diagram of a hardware configuration of the MFP.

### DETAILED DESCRIPTION OF THE PREFERRED EMBODIMENTS

Exemplary embodiments of the present invention are explained in detail below with reference to the accompanying drawings.

According to a first embodiment of the present invention, an exemplary case is explained in which the present invention is applied to, as an image processing apparatus, an MEP 100 with multifunction, such as a copy function, a facsimile function, a print function, a scanner function, and a function of distributing an input image (a read document image obtained through the scanner function or an image input through the FAX function).

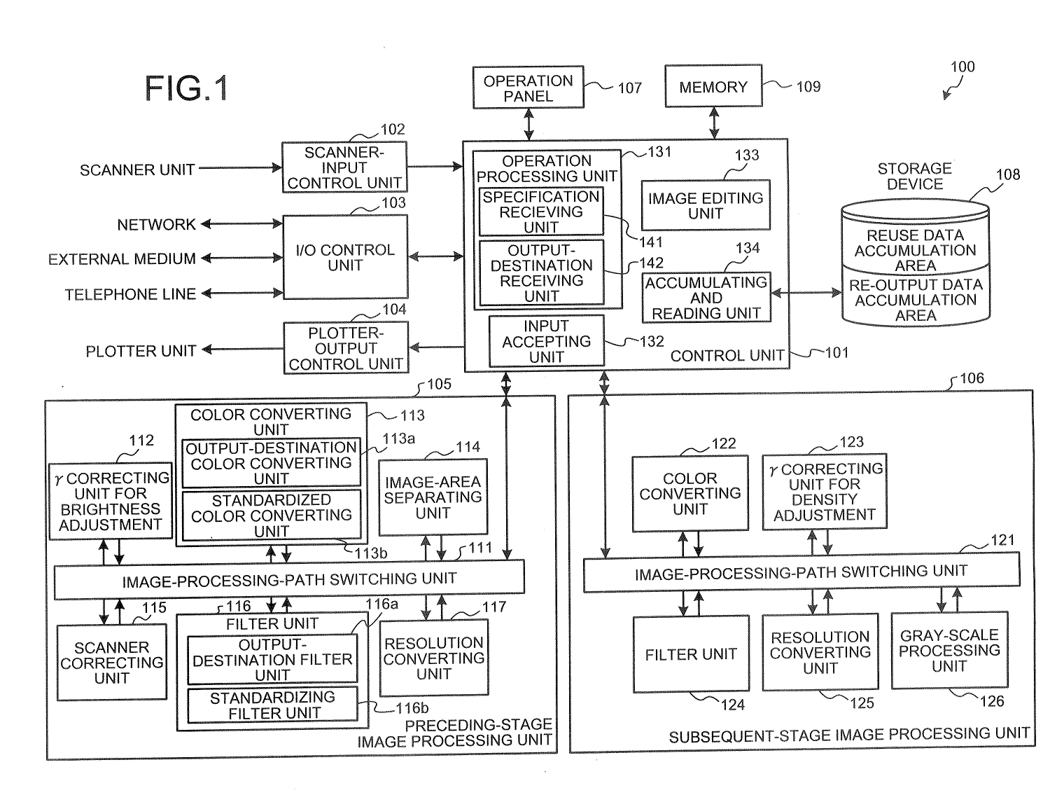

FIG. 1 is a block diagram of the configuration of the MFP according to the first embodiment. As depicted in the drawing, the MFP 100 includes a control unit 101, a scanner-input control unit 102, an input/output (I/O) control unit 103, a plotter-output control unit 104, a preceding-stage image processing unit 105, a subsequent-stage image processing unit 106, an operation panel 107, a storage device 108, and a memory 109. The MFP 100 accumulates input image data and, when receiving a request for output from a user, outputs the image data to an output destination.

The storage device 108 has a storage area for accumulating image data. Also, the storage device 108 can be configured by any generally-used storage unit, such as an HDD, an optical disk, or a random access memory (RAM).

Also, the storage device 108 accumulates image data input from, for example, the scanner-input control unit 102 or the I/O control unit 103, which will be explained further below, after image processing, which will also be explained further below. The image data accumulated in the storage device 108 is then read according to a user's request.

Furthermore, the storage device 108 has storage areas including a reuse data accumulation area in which image data is accumulated in a reuse data format and a re-output data accumulation area in which image data is accumulated in a re-output data format. With this, upon reading by the control unit 101, it is possible to determine based on the storage area whether the image data is in a reuse data format or a re-output data format.

The reuse data format is defined herein as a format in which the user can arbitrarily determine an output destination after data is accumulated in the storage device 108 and then output from the MFP 100. That is, image data in the reuse data format is defined herein as image data stored in a common format irrespective of the input source.

Also, the reuse data format is a format that can be freely processed later with respect to the storage device 108. With this, after reading image data in the reuse data format from the storage device 108, the MFP 100 can perform image processing suitable for an arbitrary output destination for output to the output destination.

The re-output data format is defined herein as a format suitable for each output destination at the time of accumulation without consideration of changing an output destination at the time of output. For this reason, image data in the re-output data format is stored in an optimal format for each output destination.

Also, since the image data in the re-output data format has been accumulated after image processing tailored in advance to the output destination, setting at the time of reading from the storage device 108 for output can be simplified.

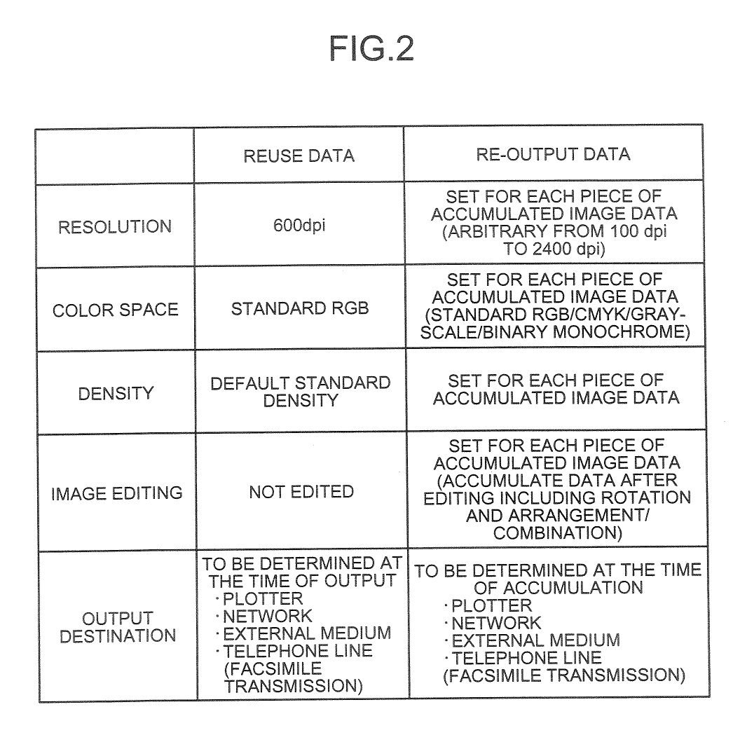

FIG. 2 is a drawing for explaining, for each item, a difference between the reuse data format and the re-output data format. As depicted in the drawing, the resolution in the reuse data format is assumed to be at a standard resolution (for example, 600 dots per inch (dpi)) across the board, and is changed to an arbitrary resolution for output at the time of reuse according to the output destination. On the other hand, the re-output data format has the output destination predefined in advance, its resolution is set for each piece of image data according to the output destination (for example, 100 dpi to 2400 dpi).

Also, a color space in the reuse data format is assumed to be a standardized RGB color space across the board. Image data in the reuse data format is output as being converted to a color space required according to the output destination at the time of reuse after being read from the storage device 108. For example, when the output destination is a plotter for printing on paper, the image data is output as being converted to a CMY color space. When the output destination is a personal computer (PC), the image data is output as being converted to an RGB color space optimized for monitor display.

On the other hand, a color space in the re-output data format is subjected to a different color space conversion for each piece of image data according to the output destination before being accumulated. For example, when the output destination is a plotter, image data converted to a CMY color space is accumulated in the storage device 108. When the output destination is a PC, image data converted to an RGB color space optimized for monitor display is accumulated.

Also, the density of the reuse data format is set at a standardized predefined density. At the time of reuse, according to a setting value adapted to a user's request, the density is converted and is then output. On the other hand, in the re-output data format, the density is converted for each piece of image data according to the setting by the user at the time of accumulation and the output destination.

Furthermore, image data in the reuse data format is not subjected to image editing, such as rotation or combination, before accumulation, but is accumulated after being rendered to a format of a standardized arrangement. Then, according to a setting value adapted to a user's request at the time of reuse, the image data is output after being subjected to image editing. On the other hand, image data in the re-output data format has been subjected to editing, such as rotation or combination, before accumulation according to the output destination.

Moreover, the image data in the reuse data format is accumulated with an output destination not particularly determined at the time of accumulation, and the user sets an output destination at the time of reuse. That is, for the image data in the reuse data format, image processing is performed according to the output destination at the time of reuse. Therefore, at the time of accumulation, the image data is accumulated in a standard format that can be subjected to image processing. On the other hand, the image data in the re-output data format has an output destination already set before accumulation, and the output destination is not allowed to be changed at the time of re-output. Also, there is no difference between output destinations that can be set for the image data in the reuse data format and those that can be set for the image data in the re-output data format. In the present embodiment, for example, a plotter, a network, an external medium, or a telephone line can be set as an output destination.

That is, the image data in the reuse data format is accumulated in a standardized image format, and therefore the image data can be provided with flexibility at the time of reuse. On the other hand, the image data in the re-output data format is accumulated in an image format specific to its output destination, and therefore the image data can be output without requiring complicated settings at the time of re-output.

Referring back to FIG. 1, the memory 109 is used as an input/output buffer for image data in the control unit 101. Also, when an image editing unit 133, which will be explained further below, included in the control unit 101 edits the image, the memory 109 is also used as a work memory at the time of image rotation and arrangement.

The operation panel 107 includes hardware keys, such as an initialization key, a copy key, a copy ten-digit keypad, and a clear/stop key, as well as a liquid-crystal touch panel. Information about input operation received by the operation panel 107 from the user is output to an operation processing unit 131, which will be explained further below, included in the control unit 101.

The scanner-input control unit 102 controls input processing of image data read by the scanner unit for output to the control unit 101.

The I/O control unit 103 controls input/output processing of image data with respect to an external device connected to the MFP 100 via a network, a telephone line, or the like, or an external medium attached to the MFP 100.

The plotter-output control unit 104 controls output processing of image data from the control unit 101 to the plotter, for the purpose of performing printing from the MFP 100.

The control unit 101 includes the operation processing unit 131, an input receiving unit 132, the image editing unit 133, and an accumulating and reading unit 134.

The operation processing unit 131 includes a specification receiving unit 141 and an output-destination receiving unit 142, and processes operation information input from a Personal Computer (PC) used by the user connected via the operation panel 107 or a network. That is, the operation processing unit 131 acquires a setting value set by the user from the input operation information. Then, according to the acquired setting value, the input receiving unit 132 or the image editing unit 133 performs processing. Here, the operation information is assumed to be information that is input by operating an input device or the operation panel 107 connected to the PC or the like.

The specification receiving unit 141 receives, from the input operation information, a specification of whether the image data is accumulated as a re-output data format or a reuse data format. A scheme for setting the reuse data format or the re-output data format by the user from the operation panel or the PC may be arbitrary. In one scheme that is different from the scheme in the present embodiment, only the specification of the output destination may be received from the user, and according to the output destination received from the user, the reuse data format or the re-output data format may be automatically specified within the apparatus.

Before receiving a specification of the re-output data format or the reuse data format, the specification receiving unit 141 may receive a specification of whether the image data is to be accumulated. In this case, the specification receiving unit 141 receives a specification of the re-output data format or the reuse data format only when it is specified that the image data is to be accumulated.

The output-destination receiving unit 142 receives, from the input operation information, a setting of an output destination of the image data after accumulation. Also, when the output-destination receiving unit 142 receives a setting of an output destination of image data in the re-output data format, appropriate image processing is performed according to the output destination set in the preceding-stage image processing unit 105, which will be explained further below.

The input receiving unit 132 receives, based on the specification received by the specification receiving unit 141, an input of the image data subjected to input processing at the scanner-input control unit 102 or the I/O control unit 103 as the re-output data format or the reuse data format.

The image editing unit 133 performs editing, such as rotation, arrangement/combination, and others, on the image data. Furthermore, the image editing unit 133 performs editing on the image data in the reuse data format after being read from the storage device 108. On the image data in the re-output data format, the image editing unit 133 performs editing before accumulation. With this, the MFP 100 can quickly and easily output the image data in the re-output data format after reading without requiring editing. Also, as for the image data in the reuse data format, the MFP 100 can edit the image data according to a request at the time of output.

The accumulating and reading unit 134 accumulates image data in the storage device 108 or reads image data from the storage device 108.

The preceding-stage image processing unit 105 includes an image-processing-path switching unit 111, a γ correcting unit 112 for brightness adjustment, a color converting unit 113, an image-area separating unit 114, a scanner correcting unit 115, a filter unit 116, and a resolution converting unit 117, and performs image processing on the image data subjected to input processing before being accumulated in the storage device 108.

The image-processing-path switching unit 111 switches a path for image processing to be performed according to whether the input image data received by the input receiving unit 132 is image data to be accumulated in the re-output data format, image data to be accumulated in the reuse data format, or image data not to be accumulated. Also, in the case of the image data to be accumulated in the re-output data format, the image-processing-path switching unit 111 sets parameters on each component for performing image processing according to the output destination.

The color converting unit 113 includes an output-destination color converting unit 113a and a standardized color converting unit 113b, and performs conversion of color spaces, such as RGB and CMY. The output-destination color converting unit 113a performs color space conversion suitable for each output destination on the image data to be accumulated in the re-output data format. The standardized color converting unit 113b performs color space conversion on the image data to be accumulated in the reuse data format to standardized RGB.

The filter unit 116 includes an output-destination filter unit 116a and a standardizing filter unit 116b, and performs edge enhancement and smoothing. The output-destination filter unit 116a performs filtering suitable for each output destination on the image data to be accumulated in the re-output data format. The standardizing filter unit 116b performs filtering for standardization on the image data to be accumulated in the reuse data format.

The γ correcting unit 112 for brightness adjustment adjusts brightness of image data. The image-area separating unit 114 specifies an image portion, such as a character portion, a photographic portion, or a dot portion. The scanner correcting unit 115 performs data correction on image data input through the scanner.

The resolution converting unit 117 reduces or magnifies, or resolution-converts the image data to be accumulated in the re-output data format according to the output destination, and resolution-converts the image data to be accumulated in the reuse data format to a standard resolution (for example, 600 dpi). In the case of the image data to be accumulated in the reuse data format, the resolution converting unit 117 may not perform resolution conversion so that the resolution of the image data can be converted to a resolution required by the output destination at the time of reuse without deterioration in image quality.

The subsequent-stage image processing unit 106 includes an image-processing path switching unit 121, a color converting unit 122, a γ correcting unit 123 for density adjustment, a filter unit 124, a resolution converting unit 125, and a gray-scale processing unit 126, and performs image processing on the image data read from the storage device 108 before being distributed to the output destination.

The image-processing path switching unit 121 switches a path for image processing according to whether the input image data is image data to be accumulated in the reuse data format, image data to be accumulated in the re-output data format, and, in the case of the image data to be accumulated in the reuse data format, according to the output destination. In particular, in the case of the image data to be accumulated in the reuse data format, the image-processing-path switching unit 121 arbitrarily switches parameters and procedures including color conversion, filter, density adjustment, resolution conversion, and gray-scale processing, thereby allowing image processing to be performed with process contents being changed according to requirements from the output destination.

The color converting unit 122 performs color space conversion according to the output destination. The γ correcting unit 123 for density adjustment adjusts density of the image data according to the output destination. The filter unit 124 performs edge enhancement and smoothing according to the output destination. The resolution converting unit 125 reduces or magnifies, or resolution-converts the image data according to the output destination. The gray-scale processing unit 126 performs gray-scale conversion on the image data.

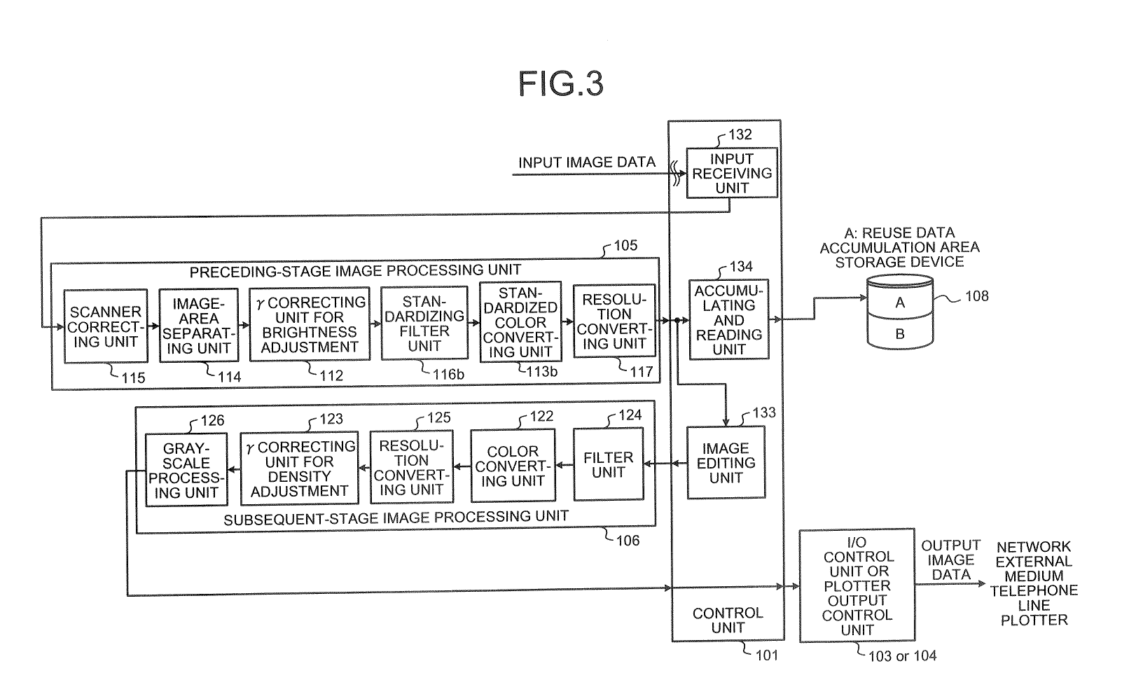

FIG. 3 is a drawing for explaining the configuration and order for use until the MFP 100 accumulates image data in the storage device 108 as a reuse data format and outputs the image data. In this example shown in the drawing, the input receiving unit 132 receives an input of image data as a reuse data format. In the case of receiving an input of image data as a reuse data format, the user can arbitrarily select an output destination after storage. Therefore, the preceding-stage image processing unit 105 performs only common image processing irrespectively of the output destination so that image processing optimal to the output destination can be performed on the image data.

For example, the standardizing filter unit 116b performs filtering so as to standardize the image data to the reuse data format. Also, the standardized color converting unit 113b converts the image data to an RGB color space standardized independently of the output destination so that the image data can be easily converted to a color space optimized for the output destination at the time of reuse. Similarly, in other components, image processing for allowing reuse is performed. Here, for the purpose of facilitating explanation, the process performed at the image-area separating unit 114 is not explained herein, and will be explained further below in detail.

After the image processing at the preceding-stage image processing unit 105, the control unit 101 receives the image data. Then, the accumulating and reading unit 134 accumulates the image data subjected to image processing in a reuse data accumulation area of the storage device 108.

When the image data is accumulated and output simultaneously, the image data is stored in the storage device 108, and also the image editing unit 133 performs image editing on the received image data. After the image editing is completed, the control unit 101 outputs the image data to the subsequent-stage image processing unit 106. The subsequent-stage image processing unit 106 then performs image processing suitable for the output destination on the input image data. For example, the color converting unit 122 performs conversion to a color space suitable for the output destination, whilst the resolution converting unit 125 performs conversion to a resolution desired by the output destination.

After the image processing is completed, the image data is again passed to the control unit 101. The control unit 101 then outputs the image data via the I/O control unit 103 or the plotter-output control unit 104 to the output destination, such as a network, an external media, a telephone circuit, or a plotter.

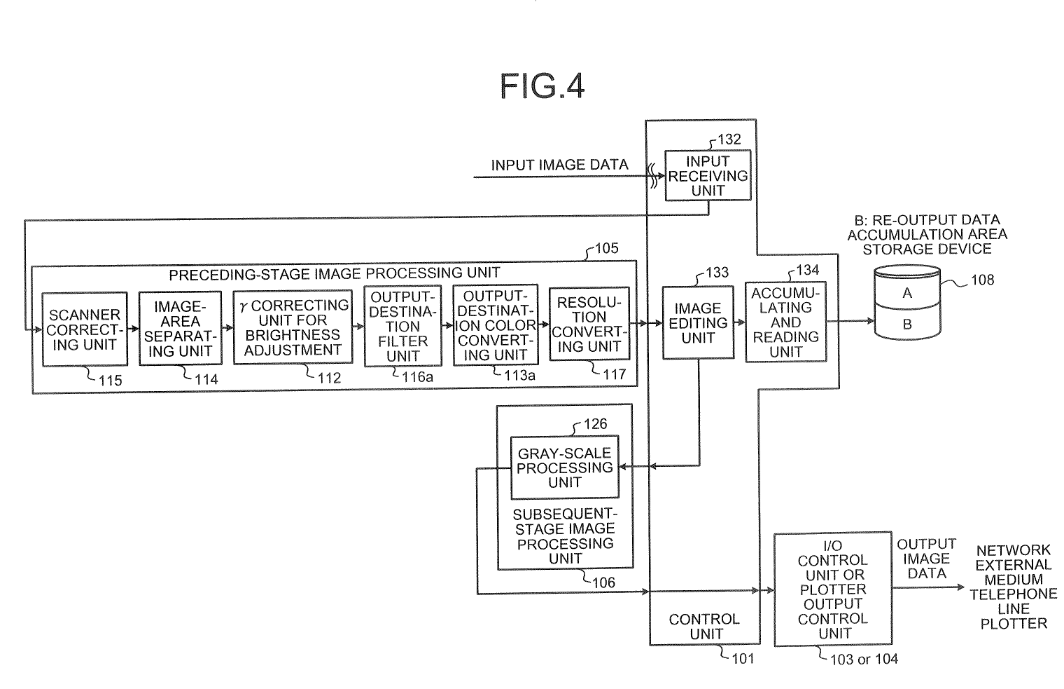

FIG. 4 is a drawing for explaining the configuration and order for use until the MFP 100 accumulates image data in the storage device 108 as a re-output data format and outputs the image data. In this example depicted in the drawing, the input receiving unit 132 receives the image data as a re-output data format. In the case of receiving the image data as a re-output data format, the user has to previously select an output destination before storage. With this, image processing optimized for the output destination is performed before the preceding-stage image processing unit 105 accumulates the image data in the storage device 108.

For example, the output-destination color converting unit 113a performs conversion on the image data to be accumulated in the re-output data format to a color space required by the output destination. Specifically, when the output destination is a plotter, the output-destination color converting unit 113a performs conversion on the image data to a CMY color space. When the output destination is a PC connected to a network, the output-destination color converting unit 113a performs conversion to an RGB color space according to the characteristics of a monitor of the PC.

In another example, the resolution converting unit 117 resolution-converts the image data to a resolution required by the output destination.

After image processing is performed by the preceding-stage image processing unit 105, the control unit 101 receives the image data. Then, the image editing unit 133 performs image editing, such as rotation, arrangement, or combination, on the image data. Then, the accumulating and reading unit 134 accumulates the image data subjected to image processing and image editing in a re-output data accumulation area of the storage device 108.

When the image data is accumulated and output simultaneously, the image data is stored in the storage device 108, and also the control unit 101 outputs the image data to the subsequent-stage image processing unit 106. On the input image data, image processing according to the output destination has already been performed. Therefore, the gray-scale processing unit 126 of the subsequent-stage image processing unit 106 performs only a process of changing the gray-scale to a gray-scale set through the operation panel or the like by the user.

After the image processing is completed, the image data is again passed to the control unit. The control unit 101 then outputs the image data via the I/O control unit 103 or the plotter-output control unit 104 to the output destination, such as a network, an external media, a telephone circuit, or a plotter.

In the MFP 100 according to the present embodiment, color space conversion and resolution conversion suitable for each output destination are performed in advance on the image data in the re-output data format. This allows image processing that is specific to the output destination by determining the output destination in advance at the time of accumulation so as to prohibit use for other purposes. Here, a scheme of retaining the output destination for each piece of image data in the re-output data format is not restricted to a known scheme, and any scheme can be used.

With this, at the time of re-output, setting on subsequent-stage image processing and actual image processing are omitted. That is, with simple output by using the image data in the re-output data format, quick and simple printing can be achieved. Furthermore, since the same image data is output every time, the same output result can be obtained every time. Still further, as for the image data in the re-output data format, setting and image processing at the time of re-output can be simplified by limiting the output destination in advance.

The image data in the reuse data format does not have an output destination defined at the time of accumulation. Therefore, image processing performed before accumulation is restricted to standardizing processing independently of the output destination. With this, at the time of output, the user can select various output destinations and image processing units for the image data in the reuse data format. Thus, reusability of the accumulated image data in the reuse data format is improved. Also, in the present embodiment, a common resolution allows easy image editing, such as combination of a plurality of pieces of image data.

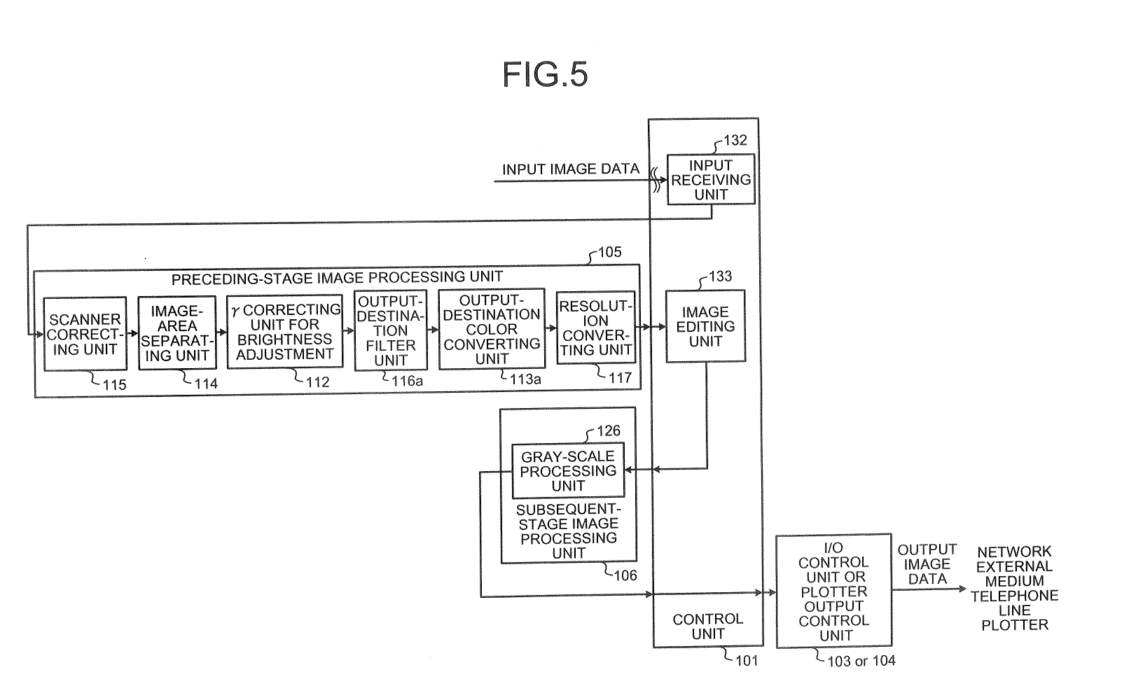

FIG. 5 is a drawing for explaining the configuration and order for use until the MFP 100 outputs image data to the output destination without accumulating the image data in the storage device 108. Image data not to be accumulated may be handled in an arbitrary manner. In this example depicted in the drawing, it is assumed that, when the image data is not to be accumulated, the input receiving unit 132 receives an input of the image data not as a re-output data format or a reuse data format, but as merely a piece of image data. However, in the image processing procedure depicted in the drawing, although accumulation is not performed, the output destination has been set. Therefore, the procedure is approximately similar to that in the case of the re-output data format explained above.

That is, after the preceding-stage image processing unit 105 performs image processing on the input image data according to the output destination, the image data is input to the control unit 101. Then, the image editing unit 133 performs image editing on the image data. Then, the control unit 101 outputs the image data to the subsequent-stage image processing unit 106. Then, the gray-scale processing unit 126 of the subsequent-stage image processing unit 106 performs only a process of changing the gray-scale to a gray-scale set through the operation panel or the like by the user. The image data is then output through the I/O control unit 103 or the plotter-output control unit 104 connected to the control unit 101.

Also, in the present embodiment, an example has been explained in which the preceding-stage image processing unit 105 performs image processing in the case of not accumulating the image data. However, a feature of the present invention is that the image data is classified into a reuse data format and a re-output data format for differentiating an image processing procedure at the time of accumulation from an image processing procedure at the time of output, thereby increasing convenience. Therefore, in the case of not accumulating the image data, image processing, such as accumulated color conversion and resolution conversion, may be performed by either one of the preceding-stage image processing unit 105 and the subsequent-stage image processing unit 106.

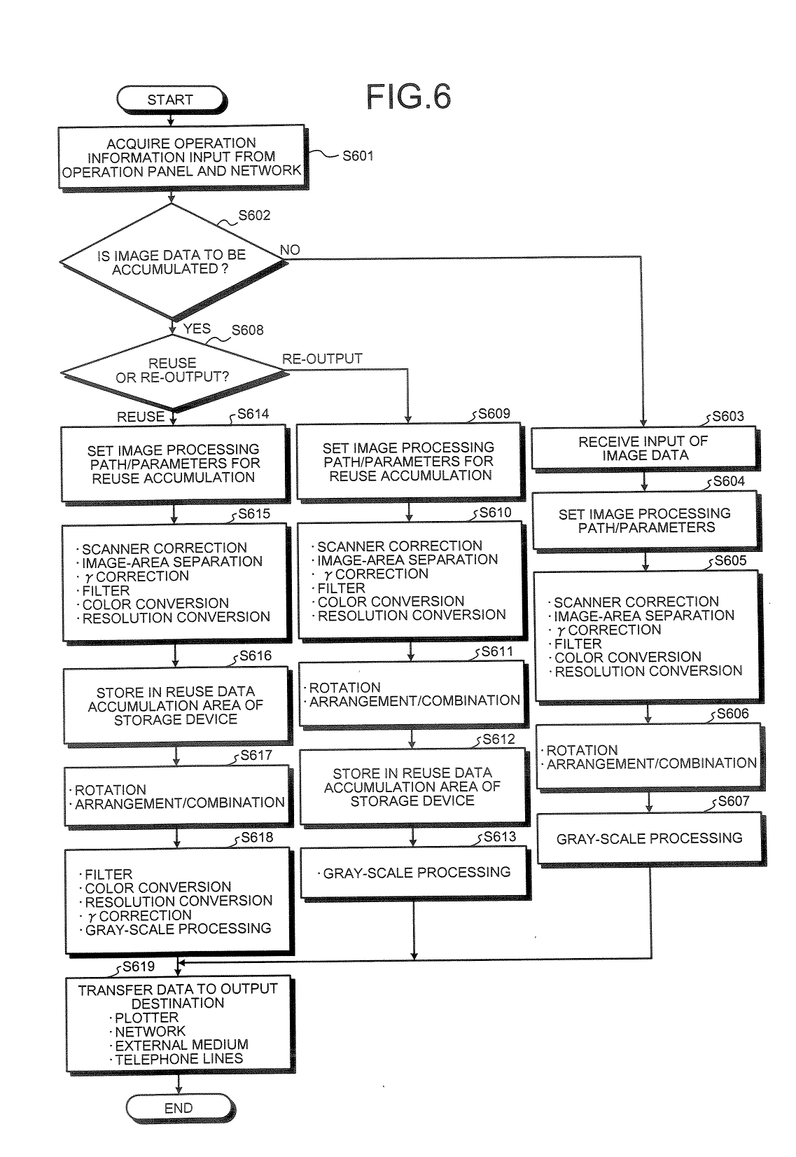

Next, a process until accumulating image data in the storage device 108 of the MFP 100 according to the present embodiment and outputting the image data to the output destination is explained. FIG. 6 is a flowchart of a procedure of such a process in the MFP 100 according to the present embodiment.

First, the operation processing unit 131 acquires operation information input by the user through the operation panel 107 or the network (step S601). Then, the specification receiving unit 141 determines based on the input operation information whether the image data is to be accumulated (step S602).

If the specification receiving unit 141 determines that the image data is not to be accumulated (“No” at step S602), an indication as such is output to the preceding-stage image processing unit 105 and the subsequent-stage image processing unit 106.

The input receiving unit 132 receives an input of the image data (step S5603). The image-processing-path switching unit 111 of the preceding-stage image processing unit 105 and the image-processing-path switching unit 121 of the subsequent-stage image processing unit 106 switch the path and set parameters so that image processing suitable for the case in which the image data is not to be accumulated, according to a setting value and the like contained in the acquired operation information (step S604).

An image processing is performed in each component of the preceding-stage image processing unit 105 (step S605). In this case, scanner correction by the scanner correcting unit 115, image-area separation by the image-area separating unit 114, γ correction by the γ correcting unit 112 for brightness adjustment, filtering by the output-destination filter unit 116a according to the output destination, color conversion by the output-destination color converting unit 113a according to the output destination, and then resolution conversion by the resolution converting unit 117 according to the output destination are preformed in this order.

Then, the image editing unit 133 performs image editing, such as rotation and arrangement/combination, on the image data subjected to image processing by the preceding-stage image processing unit 105 (step S606).

The gray-scale processing unit 126 of the subsequent-stage image processing unit 106 performs gray-scale processing (step S5607). In this processing, the path switching and parameters set at step 5604 are used.

If the input receiving unit 132 determines that the image data is to be accumulated (“Yes” at step S602), the input receiving unit 132 receives an input of the image data as a reuse data format or a re-output data format (step S5608). Whether the image data is in the reuse data format or the re-output data format is assumed to follow the specification received by the specification receiving unit 141 from the user.

If the input is received by the input receiving unit 132 as a re-output data format, an indication as such is output to the preceding-stage image processing unit 105 and the subsequent-stage image processing unit 106.

With this, the image-processing-path switching unit 111 of the preceding-stage image processing unit 105 and the image-processing-path switching unit 121 of the subsequent-stage image processing unit 106 switch the path and set parameters so that image processing is performed with the image data as a re-output data format, according to a setting value and the like contained in the acquired operation information (step S609).

An image processing is performed in each component of the preceding-stage image processing unit 105 (step S610). Processes to be performed are similar to those to be performed at step S605, and therefore are not explained herein. That is, the preceding-stage image processing unit 105 performs image processing common to both of the image data to be accumulated and the image data to be output.

Then, the image editing unit 133 performs image editing, such as rotation and arrangement/combination, on the image data subjected to image processing by the preceding-stage image processing unit 105 (step S611).

The accumulating and reading unit 134 accumulates the image after editing as a re-output data format in the re-output data accumulation area of the storage device 108 (step S612). With this, the image data subjected to image processing suitable for the output destination is accumulated. That is, the image data is accumulated after the preceding-stage image processing unit 105 and the image editing unit 133 perform processing depending on the output destination. Therefore, when such accumulated image data is read, the image data can be immediately output to the output destination.

After accumulation, the gray-scale processing unit 126 of the subsequent-stage image processing unit 106 performs gray-scale processing (step S613). In this processing, the path switching and parameters set at step S608 are used.

If the input receiving unit 132 receives an input as a reuse data format at step S608, an indication as such is output to the preceding-stage image processing unit 105 and the subsequent-stage image processing unit 106.

With this, the image-processing-path switching unit 111 of the preceding-stage image processing unit 105 and the image-processing-path switching unit 121 of the subsequent-stage image processing unit 106 switch the path and set parameters so that image processing is performed with the image data as a reuse data format, according to a setting value and the like contained in the acquired operation information (step S614).

An image processing is performed in each component of the preceding-stage image processing unit 105 (step S615). In this case, scanner correction by the scanner correcting unit 115, image-area separation by the image-area separating unit 114, γ correction by the γ correcting unit 112 for brightness adjustment, filtering by the standardizing filter unit 116b for standardization, color conversion to a standardized RGB color space by the standardized color converting unit 113b, and then resolution conversion by the resolution converting unit 117 to the standardized resolution are preformed in this order.

The accumulating and reading unit 134 accumulates the image data after image processing as a reuse data format in the reuse data accumulation area of the storage device 108 (step S616). With this, in the case of the reuse data format, the image data is accumulated before editing that is specific to the output destination.

After accumulation, the image editing unit 133 performs editing, such as rotation and arrangement/combination, on the image data subjected to image processing by the preceding-stage image processing unit 105 (step S617).

An image processing according to the output destination is performed at each component of the subsequent-stage image processing unit 106 (step S618). In this case, filtering by the filter unit 124 according to the output destination, conversion by the color converting unit 122 to a color space according to the output destination, γ correction by the γ correcting unit 123 for density adjustment, and then gray-scale processing by the gray-scale processing unit 126 are preformed in this order. In this processing, the path switching and parameters set at step S613 are used.

The image data subjected to image processing by the subsequent-stage image processing unit 106 is then transferred to the output destination (step S619). For example, the plotter-output control unit 104 causes the image data to be output to the plotter unit, or the I/O control unit 103 causes the image data to be transmitted to an external medium, or a device connected via a network or a telephone line.

With the procedure explained above, the image data can be accumulated and also output to the output destination as a reuse data format or a re-output data format. Here, in the procedure explained above, the case has been explained in which the image data is accumulated and output to the output destination simultaneously. Alternatively, only storing the image data may be performed. In this case, the procedure ends when the image data is accumulated by the accumulating and reading unit 134.

With the procedure explained above, the image data can be accumulated and also be output to the output destination as a reuse data format or a re-output data format. Next, processing until the image data in the reuse data format or the re-output data format accumulated in the storage device 108 is output is explained.

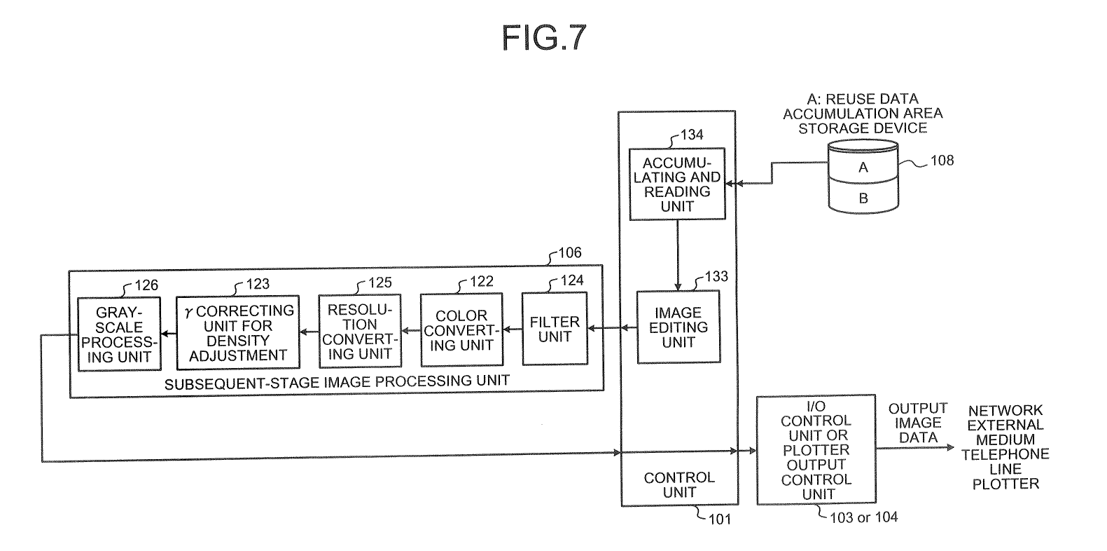

FIG. 7 is a drawing for explaining the configuration and order for use until the MFP 100 outputs image data in the reuse data format accumulated in the storage device 108 according to the output destination. Although not depicted, it is assumed that the operation processing unit 131 receives an input of selection of a reuse data format to be output and an input of parameters set at the time of output from the operation panel 107 or the I/O control unit 103.

First, the accumulating and reading unit 134 reads the image data as a reuse data format from the reuse data accumulation area of the storage device 108. Then, the image editing unit 133 performs editing, such as rotation or arrangement/combination, on the read reuse data format according to the output destination and the settings by the user. The reuse data format subjected to editing is then transferred to the subsequent-stage image processing unit 106.

The image-processing-path switching unit 121 of the subsequent-stage image processing unit 106 then switches the path and changes the parameters according to the output destination and the settings by the user. Each component after switching for performing processing performs image processing according to the destination. For example, the color converting unit 122 performs conversion to a color space according to the output destination, whilst the resolution converting unit 125 performs conversion to a resolution according to the output destination. Also, filtering, γ correction, and gray-scale processing are performed according to the output destination and the settings by the user.

After the image processing is completed, the image data is again passed to the control unit 101. The control unit 101 outputs the image data via the I/O control unit 103 or the plotter-output control unit 104 to the output destination, such as a network, an external media, a telephone circuit, or a plotter.

In the example depicted in FIG. 7, the processing according to the output destination is performed. Therefore, there is a feature in which an arbitrary output destination can be selected when the user reads a reuse data format.

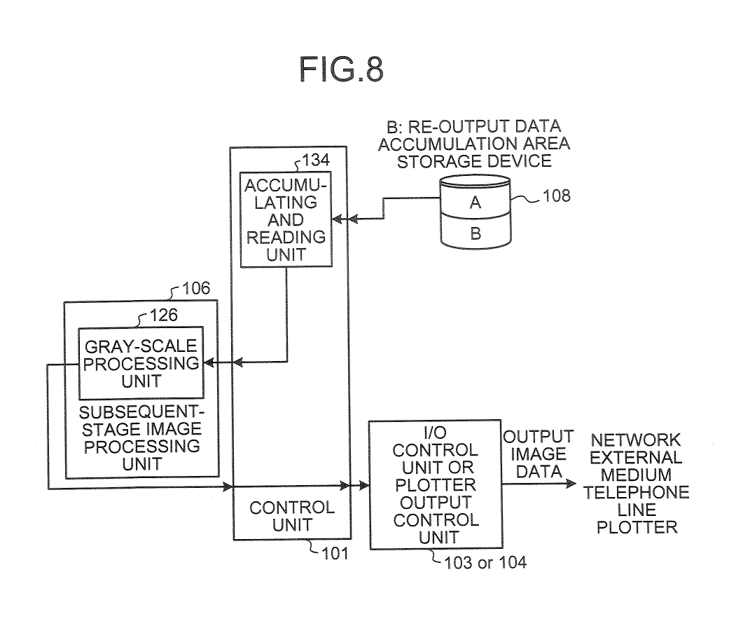

FIG. 8 is a drawing for explaining the configuration and order for use until the MFP 100 outputs image data in the re-output data format accumulated in the storage device 108. Although not depicted, it is assumed that the operation processing unit 131 receives a selection of a re-output data format to be output from the operation panel 107 or the I/O control unit 103.

First, the accumulating and reading unit 134 reads the image data as re-output data from the re-output data accumulation area of the storage device 108.

Then, the control unit 101 causes the read re-output data format to be output to the subsequent-stage image processing unit 106. The gray-scale processing unit 126 of the subsequent-stage image processing unit 106 then performs only a process of changing the gray-scale to a gray-scale set through the operation panel or the like. The image data is then output through the I/O control unit 103 or the plotter-output control unit 104 connected to the control unit 101.

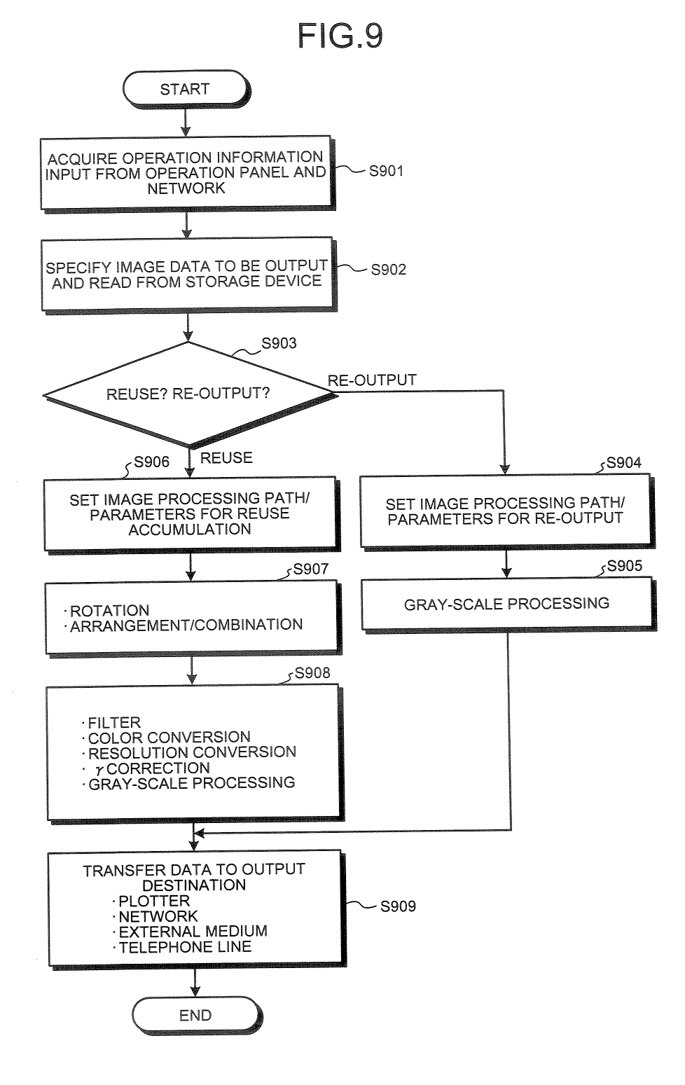

A process until the image data accumulated in the MFP 100 configured as explained above according to the present embodiment is output is explained. FIG. 9 is a flowchart of such a procedure in the MFP 100 according to the present embodiment.

First, the operation processing unit 131 acquires operation information input by the user through the operation panel 107 or the network (step S901).

Then, according to information that specifies image data contained in the operation information, the accumulating and reading unit 134 reads the image data from the storage device 108 (step S902).

The accumulating and reading unit 134 determines whether the read image data is in a reuse data format or a re-output data format (step S903). This can be determined by determining whether the area from which the image data is read is the reuse data accumulation area or the re-output data accumulation area.

Upon determination that the image data is in the re-output data format, the accumulating and reading unit 134 outputs an indication as such to the subsequent-stage image processing unit 106.

Then, the image-processing-path switching unit 121 of the subsequent-stage image processing unit 106 switches the path so as to allow only gray-scale processing, and sets gray-scale parameters based on the acquired operation information (step S904).

The gray-scale processing unit 126 of the subsequent-stage image processing unit 106 performs gray-scale processing (step S905). In this gray-scale processing, the parameters set at step S904 are used.

If it is determined by the accumulating and reading unit 134 that the image data is in the reuse data format, an indication as such is output to the subsequent-stage image processing unit 106.

With this, the image-processing-path switching unit 121 of the subsequent-stage image processing unit 106 switches the path and sets parameters so as to allow image processing according to the output destination contained in the acquired operation information or the settings by the user (step S906).

The image editing unit 133 performs editing, such as rotation or arrangement/combination, on the read image data in the re-output data format (step S907).

Each component of the subsequent-stage image processing unit 106 performs image processing according to the output destination (step S908). In this case, filtering by the filter unit 124 according to the output destination, conversion by the resolution converting unit 125 to a resolution suitable for the output destination, conversion by the color converting unit 122 to a color space according to the output destination, γ correction by the γ correcting unit 123 for density adjustment, and then gray-scale processing by the gray-scale processing unit 126 are preformed in this order. In this processing, the path switching and parameters set at step S906 are used.

The image data subjected to image processing by the subsequent-stage image processing unit 106 is then transferred to the output destination (step S909). For example, the plotter-output control unit 104 outputs the image data to the plotter unit. Alternatively, the I/O control unit 103 transmits the image data to an external medium, or a device connected via a network or a telephone line.

An image-area separation performed by the image-area separating unit 114 of a document image or a character image from image data and the following processing are explained. In the following explanation, the case of image data in the reuse data format is explained. However, similar processing can also be applied to image data in the re-output data format, and therefore is not explained herein.

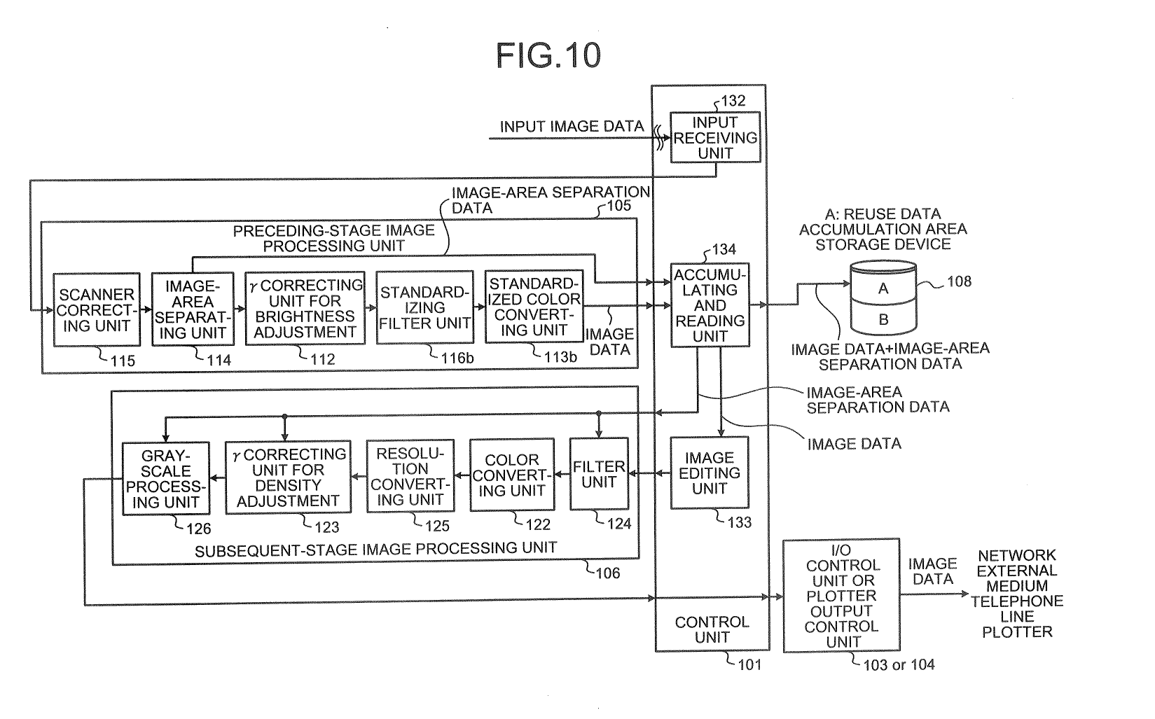

FIG. 10 is a drawing for explaining the configuration and order for use until the MFP 100 accumulates image data in the reuse data format and image-area separation data separated from the image data in the storage device 108 and outputs the image data according to the output destination.

The image-area separating unit 114 generates image-area separation data having different areas, such as a character image area and a photographic image area, separated from one another from the image data. Then, the generated image-area separation data is accumulated by the accumulating and reading unit 134 in the storage device 108 in association with the image data. Here, processes performed by other components included in the preceding-stage image processing unit 105 are similar to those of FIG. 3, and therefore are not explained herein.

The generated image-area separation data is used when the subsequent-stage image processing unit 106 performs image processing on the image data in the reuse data format according to the output destination. That is, the components included in the subsequent-stage image processing unit 106 perform image processing on the image data in the reuse data format after image editing by the image editing unit 133, by using different processing parameters for the respective areas, such as a character image area and a photographic image area specified by the image-area separation data.

For example, the filter unit 124 performs edge enhancement on the character image area, but does not perform edge enhancement on the photographic image area. As such, the filter unit 124 performs filtering by using different parameters for the respective areas. Also, the other components, such as the γ correcting unit 123 for density adjustment and the gray-scale processing unit 126, may perform processing by using different parameters for the respective areas.

Furthermore, as a matter of course, when the reuse image data accumulated in the storage device 108 is read, image-area separation data associated therewith may be also read to perform different image processes for the respective areas at the components included in the subsequent-stage image processing unit 106.

The image data subjected to image processing by the subsequent-stage image processing unit 106 is then input to the control unit 101. Then, the image data is output through the I/O control unit 103 or the plotter-output control unit 104 connected to the control unit 101 to the output destination set by the user.

Furthermore, in the MFP 100 according to the present embodiment, the accumulated image data in the reuse data format or the re-output data format can be output to a plurality of output destinations.

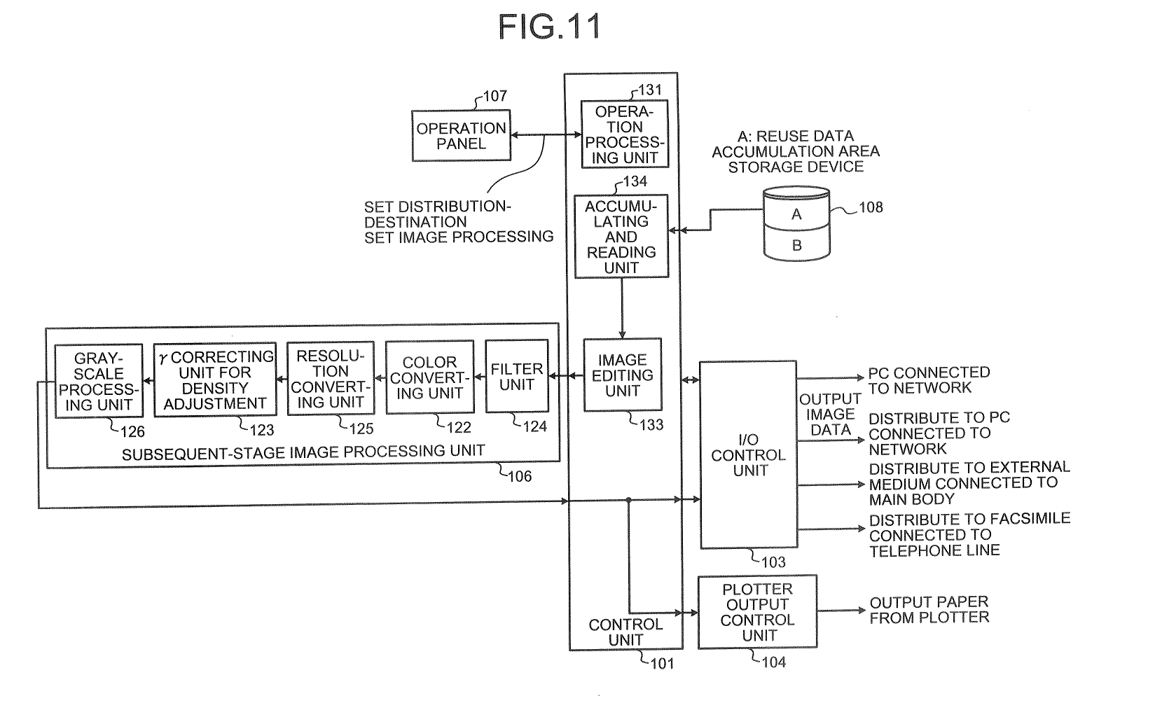

FIG. 11 is a drawing for explaining the configuration and order for use until performing image processing on the image data in the reuse data format accumulated in the MFP 100 and then outputting the result to a plurality of output destinations.

First, the operation panel 107 receives from the user a selection of a reuse data format to be output, as well as the output destination of the image data and settings of image processing to be performed on the reuse data format, and then outputs the received information to the operation processing unit 131 as operation information. Here, FIG. 11 exemplarily depicts the case in which the user sets a plurality of output destinations.

The operation processing unit 131 then processes the input operation information. With this, in the MFP 100, processing that will be explained further below is performed according to the settings input from the user. Here, the operation processing unit 131 may perform such processing not only when an input is provided from the operation panel 107, but also when an input is provided from, for example, a PC connected via a network.

The accumulating and reading unit 134 reads image data in the reuse data format from the storage device 108. The image editing unit 133 then performs image editing on the read image data in the reuse data format according to the settings performed by the user. Then, each component of the subsequent-stage image processing unit 106 performs image processing with different parameters for the respective output destinations. With this, image processing suitable for each output destination is performed.

With the subsequent-stage image processing unit 106 performing different image processing on the image data in the reuse data format for each output destination, a plurality of pieces of image data suitable for the respective output destinations are generated.

By way of more specific example, when one piece of image data in the reuse data format is output to a PC connected to a network, an external medium connected to the MFP 100, a FAX connected via a telephone line, and a plotter provided to the MFP 100 simultaneously, each component included in the image editing unit 133 and the subsequent-stage image processing unit 106 performs different editing (for example, rotation and combination) and image processing (for example, filter, color conversion, resolution, γ correction, and gray-scale processing) on the image data in the reuse data format read by the accumulating and reading unit 134.

Then, the I/O control unit 103 and the plotter-output control unit 104 output image information subjected to image editing and image processing according to the output destinations.

With this, the user does not have to set an output destination and image processing contents again and again to the same image data. That is, the MFP 100 can easily output the image data to one or more output destinations desired by the user.

In the MFP 100 according to the present embodiment, with the configuration explained above, the image data in the re-output data format is accumulated in a format suitable for the output destination, whilst the image data in the reuse data format is accumulated in a format irrespective of the output destination. Therefore, effects can be achieved such that efficiency of the process of outputting the accumulated image data is increased and adaptability to a different output pattern for each output destination is improved. Also, the image data is stored in a different format according to a difference in use purpose. Therefore, convenience at the time of reading the image data from the storage device 108 for use is increased.

Also, the image data is classified into image data in the reuse data format and image data in the re-output data format for accumulation. Therefore, appropriate image data can be output according to the user's request set before accumulation.

In the MFP 100 according to the present embodiment, based on a difference in the image data read from the storage device 108 between the reuse data format and the re-output data format, the image-processing-path switching unit 121 of the subsequent-stage image processing unit 106 switches between different image processing paths. Then, following the image processing path switched at the subsequent-stage image processing unit 106, image processing is performed. With this, image processing optimal for each piece of image data can be performed.

Furthermore, in the MFP 100 according to the present embodiment, a standardized format is used as a reuse data format. With this, image processing to be performed on the read image data in the reuse data format can be unified irrespectively of the image data.

Moreover, in the MFP 100 according to the present embodiment, a format suitable for each output destination is used as a re-output data format. That is, the accumulated image data in the re-output data format is subjected to image processing specific to the output destination. With this, image processing when the image data in the re-output data format is read for output can be simplified.

Furthermore, in the MFP 100 according to the present embodiment, the image-area separation data is accumulated in the storage device 108 in association with the image data in the reuse data format. Also, by using the image-area separation data in image processing performed before outputting the image data in the reuse data format, more appropriate image processing can be performed. That is, by adaptively switching image processing parameters for each image area with the use of the image-area separation data, more appropriate image processing can be performed for each area.

Moreover, in the MFP 100 according to the present embodiment, a plurality of output destinations of the image data in the reuse data format are simultaneously set, and image processing suitable for each output destination is performed. With this, when one piece of the image data in the reuse data format is desired to be distributed to a plurality of destinations, it is not required to perform output settings again and again. With one operation, image data can be output to the output destinations simultaneously.

According to the first embodiment, the data accumulated in association with the image data accumulated in the storage device 108 is only the image-area separation data. Alternatively, data other than this image-area separation data may be accumulated in association with the image data. Therefore, according to a second embodiment of the present embodiment, a case in which bibliographic information is accumulated in association with the image data is explained.

An MFP 1200 according to the second embodiment is different from the MFP 100 according to the first embodiment in that the control unit 101 is replaced by a control unit 1201 whose process is different. In the following explanation, components identical to those in the first embodiment are provided with the same reference numerals, and are not explained.

The control unit 1201 is different in configuration from the control unit 101 according to the first embodiment in that the accumulating and reading unit 134 is changed to an accumulating and reading unit 1211 whose process is different, and that a bibliographic information processing unit 1212 is added.

When the image data in the re-output data format is accumulated in the storage device 108, the accumulating and reading unit 1211 accumulates bibliographic information in association with the image data in the re-output data format.

This bibliographic information has stored therein setting information for use at the time of output. For example, such setting information stored in the bibliographic information includes an output destination, switching of the image processing path, and parameters for use for image processing. Also, in the present embodiment, if the bibliographic information has stored therein, before accumulation, path switching or parameters set in advance by the user, image processing may be performed when the image data in the re-output data format is output. With this, versatility can be provided, to some degree, even to image data in the re-output data format with its output destination being limited.

When reading the image data in the re-output data format, the accumulating and reading unit 1211 reads the associated bibliographic information. The bibliographic information read by the accumulating and reading unit 1211 is then output to the bibliographic information processing unit 1212, which will be explained below.

The bibliographic information processing unit 1212 processes the bibliographic information input from the accumulating and reading unit 1211. Specifically, when the bibliographic information has stored therein an output destination, the bibliographic information processing unit 1212 notifies the I/O control unit 103 and the plotter-output control unit 104 of that output destination. Also, when the bibliographic information has stored therein parameters for use in path switching and image processing, the bibliographic information processing unit 1212 notifies the image-processing-path switching unit 121 of the subsequent-stage image processing unit 106 of path switching and the parameters. With such processing performed by the bibliographic information processing unit 1212, image processing and image output can be possible according to the bibliographic information.

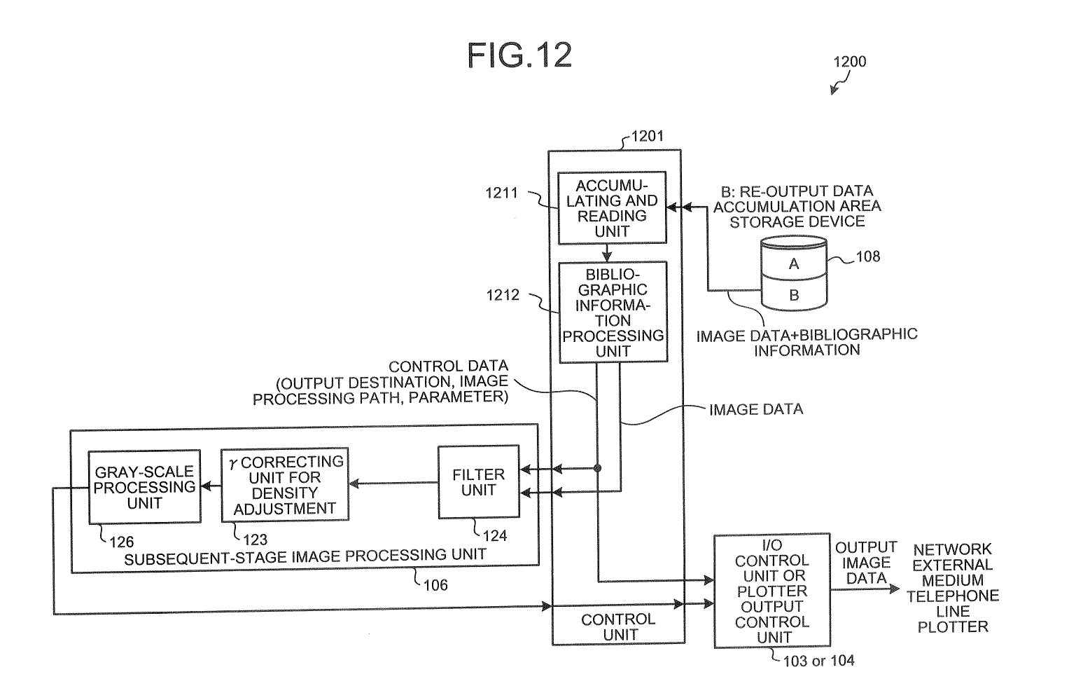

FIG. 12 is a drawing for explaining the configuration and order for use until the MFP 1200 reads the image data in the re-output data format and bibliographic information from the storage device 108 and performs image processing and output processing according to settings stored in the bibliographic information. It is assumed that the storage device 108 depicted in the drawing has previously accumulated therein bibliographic information associated with the image data in the re-output data format.

When outputting the image data in the re-output data format, the accumulating and reading unit 1211 reads the image data in the re-output data format and its bibliographic information from the re-output data accumulation area of the storage device 108. The read image data in the re-output data format and bibliographic information is then input to the bibliographic information processing unit 1212.

The bibliographic information processing unit 1212 then develops the bibliographic information to generate control data indicating path switching for use in the subsequent-stage image processing unit 106 and parameters for use in image processing. The bibliographic information processing unit 1212 then outputs the generated control data to the subsequent-stage image processing unit 106, the I/O control unit 103, and the plotter-output control unit 104.

After outputting the control data, the bibliographic information processing unit 1212 outputs the corresponding image data to the subsequent-stage image processing unit 106. Thereafter, the subsequent-stage image processing unit 106, the I/O control unit 103, and the plotter-output control unit 104 perform processing on the image data according to the control data. Finally, the I/O control unit 103 and the plotter-output control unit 104 outputs the image data subjected to image processing to the output destination specified by the control data.

The procedure performed in the MFP 1200 according to the present embodiment configured as explained above is similar to the procedure according to the first embodiment, except that the accumulating and reading unit 1211 stores the image data together with the bibliographic information and that the bibliographic information is read when the image data is read and each component is controlled by following the control data generated according to the bibliographic information, and therefore is not explained herein.

In the MFP 1200 according to the present embodiment, a different output destination, resolution, color space, density, edit information are taken as bibliographic information for each piece of image data in the re-output data format, and the bibliographic information is accumulated in the storage device 108 in association with the image data in the re-output data format. With this, the MFP 1200 can manage a profile for each piece of image data in the re-output data format.

In the MFP 1200 according to the present embodiment, by using information contained in the bibliographic information, the output destination and image processing can be set at the time of outputting the image data in the re-output data format. With this, the image data can be easily output without requiring the user to perform complicated output settings at the time of output.

Furthermore, in the present embodiment, image processing can be performed on the image data in the re-output data format according to the bibliographic information. For example, although it is difficult, for example, to change binarized image data for FAX to a format for PC, it would be possible, for example, to convert image data generated for output to a PC into a format with a low resolution for display on a cellular phone. As such, flexibility can be improved to some extent.

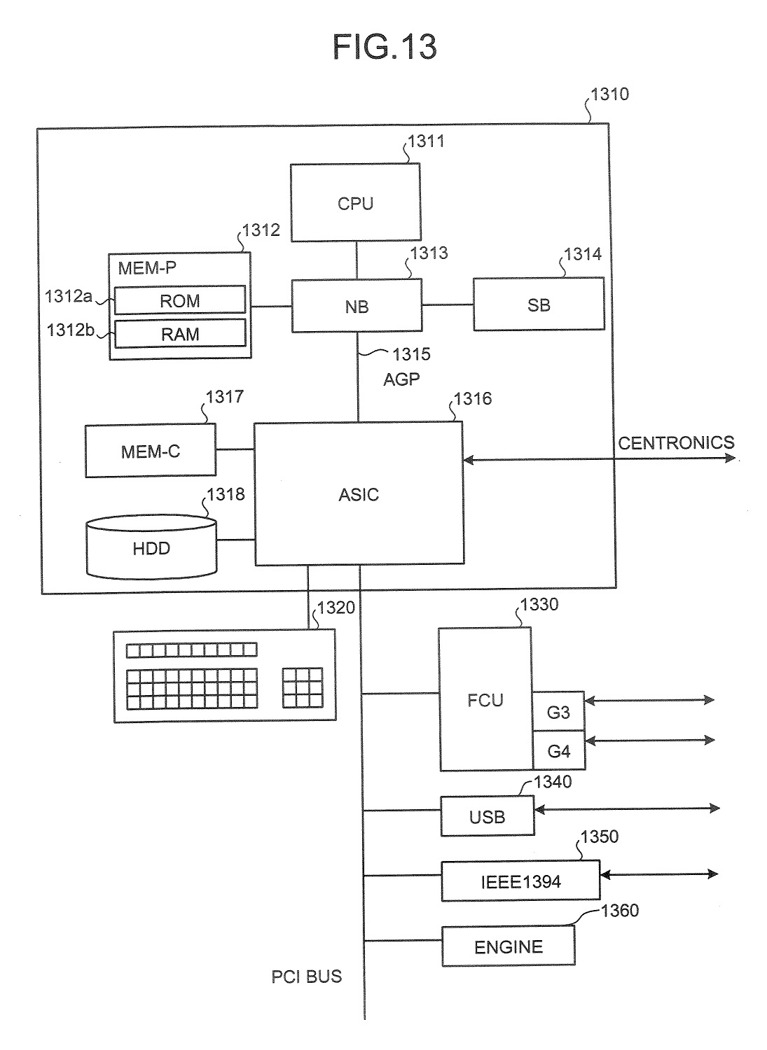

FIG. 13 is a block diagram of a hardware configuration of the MFP according to the embodiments. As depicted in the drawing, this MFP is configured with a controller 1310 and an engine unit 1360 being connected to each other via a Peripheral Component Interconnect (PCI) bus. The controller 1310 is a controller that controls the entire MFP, rendering, communications, and an input from an operating unit 1320. The engine unit 1360 is, a printer engine connectable to the PCI bus, and is, for example, a black-and-white plotter, a 1-drum color plotter, a 4-drum color plotter, a scanner, or a facsimile unit. The engine unit 1360 includes, in addition to a so-called engine portion, such as a plotter, image processing portions for error diffusion, gamma transformation, and others.

The controller 1310 includes a central processing unit (CPU) 1311, a NorthBridge (NB) 1313, a system memory (MEM-P) 1312, a SouthBridge (SB) 1314, a local memory (MEM-C) 1317, an application specific integrated circuit (ASIC) 1316, and an HDD 1318, with the NB 1313 and the ASIC 1316 being connected therebetween with an accelerated graphics port (AGP) bus 1315. Also, the MEM-P 1312 further includes a read only memory (ROM) 1312a and a RAM 1312b.

The CPU 1311 performs controls over the entire MEP, includes a chip set formed of the NB 1313, the MEM-P 1312, and the SB 1314, and is connected to other devices via this chip set.

The NB 1313 is a bridge for connection of the CPU 1311 with the MEM-P 1312, the SB 1314, and the AGP bus 1315, and includes: a memory controller that controls, for example, reading and writing with respect to the MEM-P 1312; a PCI master; and an AGP target.

The MEM-P 1312 is a system memory for use as, for example, a memory for storing programs and data, a memory for developing programs and data, or a printer's memory for rendering, and includes the ROM 1312a and the RAM 1312b. The ROM 1312a is a read-only memory for use as a memory for storing basic programs and data, whilst the RAM 1312b is a writable and readable memory for use as, for example, a memory for storing programs, a memory for developing programs and data or a printer's rendering memory.

The SB 1314 is a bridge for connection of the NB 1313 with PCI devices and peripheral devices. The SB 1314 is connected to the NB 1313 via the PCI bus. To this PCI bus, a network interface (I/F) unit is also connected, for example.

The ASIC 1316 is an Integrated Circuit (IC) dedicated to image processing, contains hardware components for image processing, and serves as a bridge for connecting the AGP bus 1315, the PCI bus, the HDD 1318, and the MEM-C 1317. The ASIC 1316 includes: a PCI target; an AGP master; an arbiter (ARB), which is a core of the ASIC 1316; a memory controller that controls the MEM-C 1317; a plurality of direct memory access controllers (DMACS) for image data rotation and others by a hardware logic and others; and a PCI unit for data transfer with the engine unit 1360 via the PCI bus. To the ASIC 1316, a fax control unit (FCU) 1330, a universal serial bus (USB) 1340, and the Institute of Electrical and Electronics Engineers (IEEE) 1394 interface 1350 are connected via the PCI bus.

The MEM-C 1317 is a local memory for use as an image buffer for copying or a coding buffer. The HDD 1318 is a storage for storing image data programs, font data, and forms.

The AGP bus 1315 is a bus interface for a graphics accelerator card suggested for increasing the speed of graphic processing, and increases the speed of the graphics accelerator card by directly accessing the MEM-P 1312 with a high throughput.

Note that the image processing program executed on the MFP according to the embodiments is provided as being previously incorporated in a ROM or the like.

The image processing program executed on the MFP according to the embodiments may be configured to be provided as being recorded as a file in an installable format or an executable format on a computer-readable recording medium, such as a compact disk-read only Memory (CD-ROM), a flexible disk (FD), a compact disk recordable (CD-R), or a digital versatile disk (DVD).

Furthermore, the image processing program executed on the MFP according to the embodiments may be configured to be provided as being stored on a computer connected to a network, such as the Internet, and then being downloaded through the network. Also, the image processing program executed on the MFP according to the embodiments may be provided or distributed via a network, such as the Internet.

The image processing program executed on the MFP according to the embodiments has a module configuration including each of the components explained above (the control unit, the scanner-input control unit, the I/O control unit, the plotter-output control unit, the pre-image-processing unit, and the post-image-processing unit). As actual hardware, with the CPU (processor) reading the image processing program from the ROM for execution, each unit explained above is loaded onto a main storage device, thereby generating thereon the control unit, the scanner-input control unit, the I/O control unit, the plotter-output control unit, the pre-image-processing unit, and the post-image-processing unit.

As described above, according to an aspect of the present invention, a different image process is performed according to the format before accumulating the image data. Therefore, effects can be achieved such that efficiency of the process of outputting the accumulated image data is increased and adaptability to a different output pattern for each output destination is improved.

Furthermore, according to another aspect of the present invention, the input of the image data is received as a reuse data format or a re-output data format according to the specification from the user. Therefore, effects can be achieved such that the image data can be appropriately output according to the request from the user.

Moreover, according to still another aspect of the present invention, when the input of the image data is received as a reuse data format, the image data is converted to a predetermined format independent of the output destination. Therefore, effects can be achieved such that the image data in the reuse data format can be output after image processing irrespectively of the set output destination.

Furthermore, according to still another aspect of the present invention, after the output destination is received, the image data in the reuse data format is converted to a format suitable for the output destination. Therefore, effects can be achieved such that the image data can be appropriately output to the output destination according to the request from the user.

Moreover, according to still another aspect of the present invention, the image data converted to a format suitable for the output destination is output to the output destination. Therefore, effects can be achieved such that the user can acquire the image data from the output destination.

Furthermore, according to still another aspect of the present invention, when a plurality of output destinations are received, a process of converting image data in the reuse data format is performed for each of the output destinations. Thus, the image data can be output to each of the output destinations. Therefore, effects can be achieved such that the image data can be output to a plurality of output destinations at one operation without requiring the user to perform output settings again and again.

Moreover, according to still another aspect of the present invention, image-area separation data is accumulated in association with the image data in the reuse data format. Therefore, effects can be achieved such that flexibility in image processing to be performed at the time of outputting the image data in the reuse data format is increased.

Furthermore, according to still another aspect of the present invention, image processing is performed with a different setting value for each area by using the image-area separation data. Therefore, effects can be achieved such that appropriate image processing can be performed for each area.

Moreover, according to still another aspect of the present invention, the image data is accumulated in the storage device as the image data in the re-output data format after being converted to a format suitable for the output destination. Therefore, effects can be achieved such that the image data in the re-output data format can be quickly and easily output to the output destination after being read.

Furthermore, according to still another aspect of the present invention, the image data in the re-output data format is output to the output destination. Therefore, effects can be achieved such that the user can easily acquire the image data from the output destination.

Moreover, according to still another aspect of the present invention, the setting included in the accumulated bibliographic information is performed at the time of outputting the image data in the re-output data format. Therefore, effects can be achieved such that the image data in the re-output data format can be easily output with the setting suitable for the output destination.

Furthermore, according to still another aspect of the present invention, the output destination is set according to the bibliographic information. Therefore, effects can be achieved such that the image data in the re-output data format can be output to the output destination after being read.

Moreover, according to still another aspect of the present invention, image processing can be performed on the image data in the re-output data format according to the bibliographic information. Therefore, effects can be achieved such that flexibility is increased.

Furthermore, according to still another aspect of the present invention, editing is performed on the image data in the re-output data format before accumulation. Therefore, effects can be achieved such that editing is not required after reading, and the image data can be quickly and easily output to the output destination.

Moreover, according to still another aspect of the present invention, editing is performed on the image data in the reuse data format after being read. Therefore, effects can be achieved such that the image data can be edited according to the user's request at the time of output.

Furthermore, according to still another aspect of the present invention, a different image process is performed according to the type before the image data is accumulated. Therefore, effects can be achieved such that efficiency of the process of outputting the accumulated image data is increased and adaptability to a different output pattern for each output destination is improved.

Moreover, according to still another aspect of the present invention, a recording medium having stored therein an image processing program according to claim 17 is provided. Therefore, effects can be achieved such that the image processing program can be executed by causing a computer to read this recording medium.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an input receiving unit that receives an input of image data as either a reuse data format with an undefined output destination or a re-output data format with a defined output destination;
an image processing unit that performs a different image processing on the image data depending on a type of received data format; and
an accumulating unit that accumulates the image data, on which an image processing is performed by the image processing unit, in the received data format in a storage unit.

2. The image processing apparatus according to claim 1, further comprising a specification receiving unit that receives a specification of either the reuse data format or the re-output data format as a classification of the image data, wherein
the input receiving unit receives the input of the image data in either the reuse data format or the re-output data format according to received specification.

3. The image processing apparatus according to claim 1, wherein the image processing unit converts the image data for which the input is received as the reuse data format into a predetermined format independent of an output destination.

4. The image processing apparatus according to claim 3, further comprising:
an output-destination receiving unit that receives an output destination for the image data in the reuse data format accumulated in the storage unit;
a reading unit that reads the image data in the reuse data format accumulated in the storage unit; and
a subsequent-stage image processing unit that converts read image data into a format suitable for received output destination.

5. The image processing apparatus according to claim 4, further comprising an output processing unit that outputs the image data converted into the format suitable for the received output destination to the received output destination.

6. The image processing apparatus according to claim 4, wherein
the output-destination receiving unit receives a plurality of output destinations for the image data in the reuse data format, and
the subsequent-stage image processing unit converts the image data into a format suitable for each of the output destinations.

7. The image processing apparatus according to claim 1, further comprising an image-area separating unit that separates the image data for which the input is received as the reuse date format into different areas, wherein
the accumulating unit further accumulates image-area separation data obtained from a separation of the image data by the image-area separating unit, in association with the image data in the reuse data format in the storage unit.

8. The image processing apparatus according to claim 7, further comprising:
an output-destination receiving unit that receives an output destination for the image data in the reuse data format accumulated in the storage unit;
a reading unit that reads the image data in the reuse data format accumulated in the storage unit; and
a subsequent-stage image processing unit that converts read image data into a format suitable for received output destination, wherein
the subsequent image processing unit performs an image processing on the image data in the reuse data format with a different setting value for each of the areas by using the image-area separation data.

9. The image processing apparatus according to claim 1, further comprising an output-destination receiving unit that receives an output destination for the image data, wherein
the image processing unit converts the image data for which the input is received as the re-output data format into a format suitable for received output destination.

10. The image processing apparatus according to claim 9, further comprising:
a reading unit that reads the image data in the re-output data format accumulated in the storage unit; and
an output processing unit that outputs read image data to the received output destination.

11. The image processing apparatus according to claim 10, wherein
the accumulating unit accumulates bibliographic information including a setting to be performed at a time of outputting the image data in association with the image data in the re-output data format, and
the image processing apparatus further comprises a bibliographic information processing unit that performs the setting included in accumulated bibliographic information at the time of outputting the image data in the re-output data format.

12. The image processing apparatus according to claim 11, wherein
the accumulating unit accumulates the bibliographic information including the received output destination,
the bibliographic information processing unit sets an output destination for the image data in the re-output data format from the accumulated bibliographic information, and
the output processing unit outputs the image data to set output destination.

13. The image processing apparatus according to claim 11, wherein
the accumulating unit accumulates the bibliographic information further including information indicating an image processing to be performed on the image data in the re-output data format after reading the image data,
the bibliographic information processing unit sets an image processing to be performed on the image data in the re-output data format from the accumulated bibliographic information, and
the image processing apparatus further comprises a subsequent-stage image processing unit performs set image processing on the image data in the re-output data format.

14. The image processing apparatus according to claim 1, further comprising an editing unit that edits, when an input of image data on which an image processing is performed by the image processing unit is received as the re-output data format, the image data before the accumulating unit accumulates the image data in the storage unit.

15. The image processing apparatus according to claim 1, further comprising an editing unit that edits, when an input of image data on which an image processing is performed by the image processing unit is received as the reuse data format, the image data after the image data is read from the storage unit.

16. An image processing method comprising:
receiving an input of image data as either a reuse data format with an undefined output destination or a re-output data format with a defined output destination;
performing a different image processing on the image data depending on a type of received data format; and
accumulating the image data, on which an image processing is performed at the performing, in the received data format in a storage unit.

17. A computer program product comprising a computer usable medium having computer readable program codes embodied in the medium that when executed cause a computer to execute:
receiving an input of image data as either a reuse data format with an undefined output destination or a re-output data format with a defined output destination;
performing a different image processing on the image data depending on a type of received data format; and
accumulating the image data, on which an image processing is performed at the performing, in the received data format in a storage unit.
